(19) United States
(12) Patent Application Publication
(10) Pub. No.: US 2012/0247647 A1
(43) Pub. Date: Oct. 4, 2012

(54) METHOD OF SUCTION OF OBJECT TO BE WORKED UPON SUCTION UNIT AND METHOD OF MANUFACTURE OF CERAMIC CAPACITOR

(75) Inventors: Junichi Moriyama, Osaka (JP); Satoru Furuyama, Osaka (JP); Toshimitsu Tachibana, Osaka (JP); Yozo Nagai, Osaka (JP)

(73) Assignee: NITTO DENKO CORPORATION, Ibaraki-shi, Osaka (JP)

(21) Appl. No.: 13/515,601

(22) PCT Filed: Jan. 25, 2011
(86) PCT No.: PCT/JP2011/000389

§ 371 Date: Jun. 13, 2012

(30) Foreign Application Priority Data
Jan. 25, 2010 (JP) 2010-013448

(51) Int. Cl. C04B 35/64; B66F 11/00

(52) U.S. Cl. 156/89.12; 414/800

(57) ABSTRACT

In the method for allowing a work object (15) to be sucked onto a suction unit (14) and the method for manufacturing a ceramic capacitor according to the present invention, a resin sheet (11) that has air permeability in a thickness direction is used as a suction sheet. In the resin sheet (11), air permeability is more enhanced than that of a conventional resin sheet while the diameter (opening diameter) of holes for ensuring air permeability serving as air passages is kept small. The resin sheet (11) is a non-porous sheet in which two or more through holes extending in a thickness direction of the non-porous sheet are formed. The through holes are straight holes extending linearly through the resin sheet. The through holes have a diameter of 20 μm or less. The resin sheet has an air permeance, in the thickness direction, of 10 seconds/100 mL or less in terms of Gurley number measured in accordance with JIS P8117. In each method according to the present invention, the resin sheet (11) is disposed on a suction face of the suction unit (14).

### TECHNICAL FIELD

The present invention relates to a method for allowing a work object to be sucked onto a suction unit, in which a resin sheet that prevents direct contact between a suction face of the suction unit and the work object is used. The present invention also relates to a method for manufacturing a ceramic capacitor, in which the resin sheet is used.

### BACKGROUND ART

In association with widespread use of small electronic devices such as mobile phones, ceramic capacitors used for these devices are required to be reduced in size and increased in capacity. Usually, the ceramic capacitors are manufactured by laminating dielectric thin films (ceramic green sheets). One technique of reducing the size and increasing the capacity of the ceramic capacitors is to reduce the thickness of the ceramic green sheets. In recent years, ceramic green sheets having a thickness of as small as 1 to 2 μm have been put in practical use.

A ceramic green sheet is formed by applying a dielectric paste to a release sheet and drying the paste. The ceramic green sheet is supplied to the manufacturing process of a ceramic capacitor, in the state of being integrated with the release sheet. The supplied ceramic green sheet is separated from the release sheet and transferred to a specified location so that the ceramic green sheet is laminated at the location. Before this separation and transfer, an electrode film may be formed on the supplied ceramic green sheet and/or the supplied ceramic green sheet may be cut, as needed. For the separation of the ceramic green sheet from the release sheet and the transfer of the separated ceramic green sheet, a suction head that sucks the ceramic green sheet by aspiration commonly is used (suction transfer). Thereby, stable separation and transfer as well as precise lamination of the ceramic green sheet are possible. Usually, the suction head is made of metal. However, fine ceramic powder contained in the ceramic green sheet tends to scar a suction face of the suction head easily. This scar makes a cause of a scar on the ceramic green sheet to be sucked later, resulting in occurrence of failure of the ceramic capacitor. Thus, for the purpose of protecting the suction face, a resin sheet (suction sheet) having air permeability is disposed on the suction face. Moreover, by disposing the suction sheet replaceably, effects such that it is possible to maintain a ceramic green sheet device without detaching the suction head can be obtained.

As one kind of the suction sheet, a porous sheet composed of ultrahigh molecular weight polyethylene (UHMWPE) can be mentioned (see Patent Literature 1, for example). The porous sheet composed of UHMWPE has excellent air permeability, surface smoothness and releasability, and is suitable for separation, suction transfer and lamination of the ceramic green sheet.

### CITATION LIST

### Patent Literature

PTL 1: JP 2006-026981 A

### SUMMARY OF INVENTION

### Technical Problem

When the thickness of the ceramic green sheet is more reduced, the ceramic green sheet comes to have air permeability, and the influence of Van der Waals force that works between the ceramic green sheet and the release sheets is increased. This increases the suction power necessary for the separation of the ceramic green sheet from the release sheet and for the suction transfer of the ceramic green sheet. Thus, it is desired to use a suction sheet having enhanced air permeability.

In order to enhance the air permeability of a sheet, it is common to use a technique of increasing the volumetric capacity of an air passage in the sheet to reduce air permeation resistance. For example, in the case of a porous sheet, the average pore diameter and/or the porosity of the sheet is increased to enhance the air permeability of the sheet. However, in the case of using the porous sheet as the suction sheet, an increase in the average pore diameter of the suction sheet causes the ceramic green sheet to be drawn easily into pores open in the suction sheet surface, inducing deformation and poor lamination of the ceramic green sheet. On the other hand, an increase in the porosity of the suction sheet causes the suction sheet to be deformed at the time of suction of the ceramic green sheet, inducing deformation and poor lamination of the ceramic green sheet. The problem of deformation and poor lamination tends to occur particularly with the ceramic green sheet having a reduced thickness. Under these circumstances, the present invention is intended to provide a method for allowing a work object to be sucked onto a suction unit and a method for manufacturing a ceramic capacitor, in both of which a resin sheet in which air permeability is more enhanced than that of a conventional resin sheet while the diameter (opening diameter) of holes for ensuring air permeability serving as air passages is kept small is used as the suction sheet.

### Solution to Problem

The suction method according to the present invention is a method for allowing a work object (suction object) to be sucked onto a suction unit, including a step of allowing the work object to be sucked onto a suction face of the suction unit. A resin sheet (suction sheet) that prevents direct contact between the work object and the suction face and has air permeability in a thickness direction of the resin sheet is disposed on the suction face. The resin sheet is a non-porous sheet in which two or more through holes extending in a thickness direction of the non-porous sheet are formed. The through holes are straight holes extending linearly through the resin sheet. The through holes have a diameter of 20 μm or less. The resin sheet has an air permeance, in the thickness direction, of 10 seconds/100 mL or less in terms of Gurley number measured in accordance with JIS P8117.

The method for manufacturing a ceramic capacitor according to the present invention includes: a separating step of allowing a ceramic green sheet formed on a release film to be sucked onto a suction face of a suction unit so as to separate the ceramic green sheet from the release film; a laminating step of transferring the separated ceramic green sheet while keeping the separated ceramic green sheet sucked on the suction face, and laminating the separated ceramic green sheet on another ceramic green sheet at a destination of transfer; and a firing step of firing a laminate of the ceramic green sheets obtained by repeating a plurality of times the separating step and the laminating step. A resin sheet (suction sheet) that prevents direct contact between the ceramic green sheet and the suction face and has air permeability in a thickness direction of the resin sheet is disposed on the suction face. The resin sheet is a non-porous sheet in which two or more through holes extending in a thickness direction of the non-porous sheet are formed. The through holes are straight holes extending linearly through the resin sheet. The through holes have a diameter of 20 μm or less. The resin sheet has an air permeance, in the thickness direction, of 10 seconds/100 mL or less in terms of Gurley number measured in accordance with JIS P8117.

### Advantageous Effects of Invention

In the suction method according to the present invention, the resin sheet that is a non-porous sheet in which two or more through holes extending in the thickness direction of the non-porous sheet are formed is disposed on the suction face of the suction unit, and the work object is sucked onto the suction unit. The through holes are straight holes extending through the resin sheet linearly. The through holes have a diameter of 20 μm or less. The resin sheet has an air permeance, in the thickness direction, of 10 seconds/100 mL or less in terms of Gurley number measured in accordance with JIS P8117. The resin sheet is a suction sheet that prevents direct contact between the work object and the suction face of the suction unit and that has air permeability in the thickness direction. The work object is sucked onto the suction face via the suction sheet. The suction sheet protects the suction face of the suction unit. The suction sheet has higher air permeability than that of a conventional resin sheet, although the holes therein for ensuring air permeability have a small diameter (opening diameter). Therefore, in the suction method according to the present invention, the work object is sucked effectively while the draw of the work object into the holes (openings) present in the surface of the suction sheet is suppressed. In the case where the work object is a ceramic green sheet used for manufacturing a ceramic capacitor, the suction method according to the present invention makes it possible to separate surely the ceramic green sheet from the release sheet, suppress the deformation of the ceramic green sheet at the time of separation and at the time of suction transfer, and suppress the occurrence of poor lamination of the ceramic green sheet in the laminating step. These effects are particularly apparent in the case where the work object is a thickness-reduced ceramic green sheet that tends to be drawn easily into the holes (openings) present in the surface of the suction sheet and that is difficult to separate from the release sheet.

In the manufacturing method according to the present invention, the resin sheet that is a non-porous sheet in which two or more through holes extending in the thickness direction of the non-porous sheet are formed is disposed on the suction face of the suction unit to manufacture the ceramic capacitor. The through holes are straight holes extending through the resin sheet linearly. The through holes have a diameter of 20 μm or less. The resin sheet has an air permeance, in the thickness direction, of 10 seconds/100 mL or less in terms of Gurley number measured in accordance with JIS P8117. The resin sheet is a suction sheet that prevents direct contact between the ceramic green sheet and the suction face of the suction unit and that has air permeability in the thickness direction. The suction unit is used in the separating step of allowing a ceramic green sheet formed on a release film to be sucked onto a suction face of a suction unit so as to separate the ceramic green sheet from the release film, and in the laminating step of transferring the separated ceramic green sheet while keeping the separated ceramic green sheet sucked on the suction face (suction transfer) and laminating the separated ceramic green sheet on another ceramic green sheet at a destination of transfer. The suction sheet protects the suction face of the suction unit. The suction sheet has higher air permeability than that of a conventional resin sheet, although the holes therein for ensuring air permeability have a small diameter (opening diameter). Therefore, in the manufacturing method according to the present invention, the ceramic green sheet is sucked effectively while the draw of the ceramic green sheet into the holes (openings) present in the surface of the suction sheet is suppressed. This makes it possible to separate surely the ceramic green sheet from the release sheet in the separating step, suppress the deformation of the ceramic green sheet at the time of separation and at the time of suction transfer, and suppress the occurrence of poor lamination of the ceramic green sheet in the laminating step. These effects are particularly apparent in the case of using a thickness-reduced ceramic green sheet that tends to be drawn easily into the holes (openings) present in the surface of the suction sheet and that is difficult to separate from the release sheet.

### BRIEF DESCRIPTION OF DRAWINGS

FIG. 1 is a plan view illustrating schematically an example of a resin sheet used in the suction method and the manufacturing method according to the present invention.

FIG. 2 is a cross-sectional view illustrating a cross-section B-B of the resin sheet shown in FIG. 1.

FIG. 3 is a cross-sectional view illustrating schematically an example of the method for allowing a work object to be sucked onto a suction unit according to the present invention.

FIG. 4A is a view illustrating schematically a separating step in an example of the method for manufacturing a ceramic capacitor according to the present invention.

FIG. 4B is a view illustrating schematically a laminating step in the example of the method for manufacturing the ceramic capacitor according to the present invention.

FIG. 4C is a view illustrating schematically a firing step in the example of the method for manufacturing the ceramic capacitor according to the present invention.

FIG. 5 is a view illustrating schematically an apparatus used to evaluate suction sheets in Examples.

FIG. 6 is a view showing a scanning electron microscope (SEM) image of the surface of the suction sheet used in Example 1.

FIG. 7 is a view showing an SEM image of the surface of the suction sheet used in Example 2.

FIG. 8 is a view showing an SEM image of the surface of the suction sheet used in Comparative Example.

### DESCRIPTION OF EMBODIMENTS

The suction sheet used in the suction method and the manufacturing method according to the present invention is a non-porous resin sheet A in which many through holes extending in a thickness direction of the non-porous resin sheet A are formed. The resin sheet A has air permeability in the thickness direction thereof and functions as the suction sheet. To be non-porous is to have no pores serving as air passages in the thickness direction other than the through holes. Typically, the resin sheet A is a resin sheet having no pores other than the through holes.

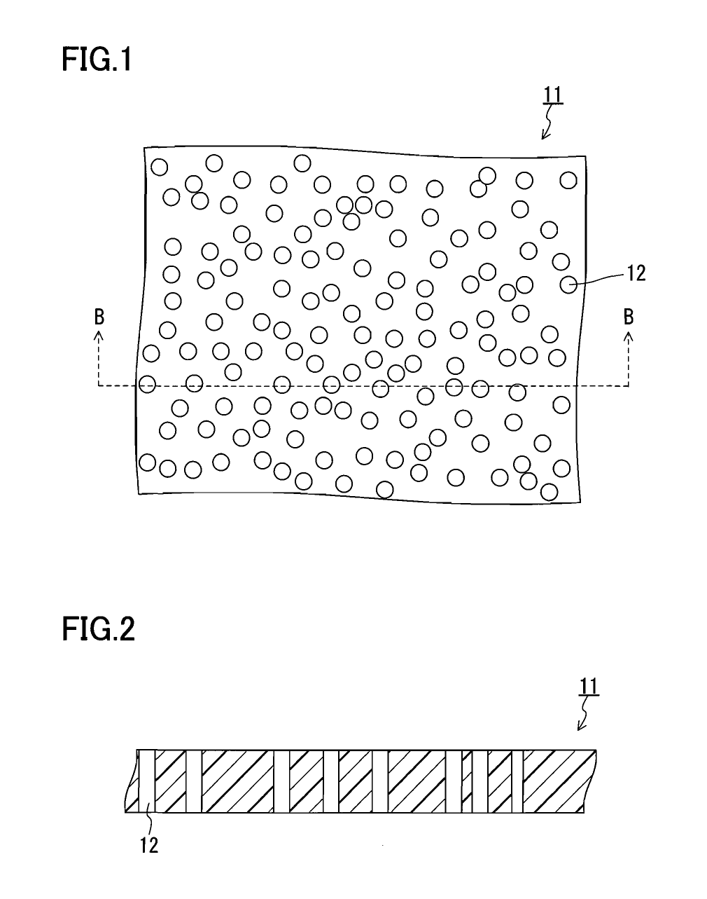

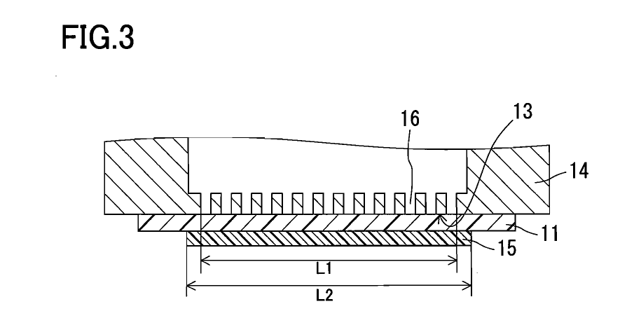

FIGS. 1 and 2 illustrates an example of the resin sheet A. FIG. 2 illustrates a cross-section B-B of a resin sheet 11 shown in FIG. 1. In the resin sheet 11, many through holes 12 extending in a thickness direction of the resin sheet 11 are formed. The resin sheet 11 has no pores other than the through holes 12.

The through holes of the resin sheet A have a diameter (opening diameter) of 20 μm or less. Thereby, in the case where the resin sheet A is used as the suction sheet, the draw of a work object (a ceramic green sheet, for example) into the holes (openings) present in the surface of the suction sheet is suppressed. When the diameter of the through holes exceeds 20 μm, the draw of the work object into the openings present in the surface of the suction sheet tends to occur more easily. Even when the draw of the work object does not occur, marks of the openings are left on the surface of the work object, resulting in that the thickness of the work object is more likely to vary. In the case where the work object is a ceramic green sheet, the variation in the thickness of the ceramic green sheet leads to the occurrence of poor lamination of the ceramic green sheet in the laminating step. Preferably, the diameter of the through holes is 10 μm or less. Such fine through holes can be formed by ion beam irradiation and etching, for example. The lower limit of the diameter (opening diameter) of the through holes is not particularly limited as long as the resin sheet A has an air permeance of 10 seconds/100 mL or less in terms of Gurley number measured in accordance with JIS P8117. For example, the lower limit is 0.8 μm.

The shape of the through holes is not particularly limited, and the openings of the through holes may have a circular or indefinite shape. In the resin sheet 11 shown in FIGS. 1 and 2, the openings of the through holes 12 have a circular shape.

The through holes 12 are straight holes extending linearly through the resin sheet A. Preferably, the diameter of the through holes 12 does not change almost at all from one main surface to the other main surface of the resin sheet A. The resin sheet A has two or more through holes. Typically, the through holes are independent from each other. Such through holes can be formed by ion beam irradiation and etching, for example. The ion beam irradiation and etching make it possible to form, in the resin sheet, many through holes having almost the same opening diameter and almost the same axis orientation as each other.

Usually, the axis of the through holes is in a direction perpendicular to the main surfaces of the resin sheet A. The axis may be tilted from the direction perpendicular to the main surfaces as long as the through holes extend in the thickness direction of the resin sheet A (as long as the through holes ensure air permeation of the resin sheet A in the thickness direction).

Conventionally, a porous sheet is used as the suction sheet. However, in the porous sheet, the shapes of pores serving as air passages are irregular, and the shapes always change along the air passages and the pores are connected intricately to each other. Thus, a porous sheet having an average pore diameter equal to the diameter of the through holes of the resin sheet A has significantly higher air permeation resistance than that of the resin sheet A, and thus has poorer air permeability. In addition, since the porous sheet has air permeability not only in a thickness direction but also in a plane direction thereof, the porous sheet suffers so-called lateral leakage of the suction power when used as the suction sheet. In the case of using the suction sheet having low air permeability and lateral leakage, a large suction pressure is needed to suck the work object, such as the ceramic green sheet. Also, the work object tends to be deformed easily at the time of suction because the suction power varies with the position on the suction sheet (the suction power lowers particularly at an edge portion of the suction sheet).

In contrast, in the resin sheet A, the extending direction of the through holes serving as air passages is the thickness direction of the resin sheet A, and the shape of the through holes does not change almost at all along the air passages. This allows the resin sheet A to be the suction sheet having very low air permeation resistance in the thickness direction and having satisfactory air permeability. Moreover, the suction sheet is free from lateral leakage.

The material composing the resin sheet A is not particularly limited. The resin sheet A is composed of, for example, a material in which the above-mentioned through holes can be formed by ion beam irradiation and etching. Examples of such a material include a material that can be decomposed (by hydrolysis and/or oxidation) using an etching treatment liquid containing an alkali substance and/or an oxidizing agent. Examples of the alkali substance include potassium hydroxide and sodium hydroxide. Examples of the oxidizing agent include chlorous acid and a salt thereof, hypochlorous acid and a salt thereof, hydrogen peroxide, and potassium permanganate.

The resin sheet A is composed of, for example, at least one resin selected from polyethylene terephthalate (PET), polycarbonate (PC), polyimide (PI), polyethylene naphthalate (PEN) and polyvinylidene fluoride (PVdF). These resins are the materials that can be decomposed using the etching treatment liquid containing the alkali substance and/or the oxidizing agent. PI can be decomposed using an etching treatment liquid that contains sodium hypochlorite as a main component. The other resins can be decomposed using an etching treatment liquid that contains sodium hydroxide as a main component.

Preferably, the resin sheet A is composed of PET because it provides the surface of the resin sheet A with high smoothness. Higher smoothness on the surface of the suction sheet suppresses the deformation of the work object at the time of suction of the work object.

Furthermore, the thickness accuracy of the resin sheet A composed of PET can be about ±2 μm for the thickness of the resin sheet A in the range of 12.5 to 100 μm. This thickness accuracy is significantly higher than the thickness accuracy (±5 μm) of a UHMWPE porous sheet prepared to have a smooth surface. In addition, the surface roughness of the resin sheet A composed of PET can be about 0.05 μm in terms of arithmetic average roughness Ra measured in accordance with JIS B0601, and can be about 0.1 μm in terms of maximum roughness Rmax. These values are significantly lower than Ra (=0.5 μm) and Rmax (=15 μm) of the UHMWPE porous sheet prepared to have a smooth surface. These properties enhance further the effects of the present invention.

The air permeance (air permeance in the thickness direction) of the resin sheet A is 10 seconds/100 mL or less, and preferably 3 seconds/100 mL or less, in terms of Gurley number measured in accordance with JIS P8117. The air permeance of the resin sheet A can be adjusted by the diameter of the through holes and the density of the through holes.

The porosity of the resin sheet A is not particularly limited. From the viewpoint of suppressing the deformation of the resin sheet A at the time of suction of the work object, the porosity preferably is 40% or less, and more preferably 30% or less. Even in the case where the porosity of the resin sheet A is as low as this, the resin sheet A has very high air permeability owing to the shape of the air passages therein.

One surface of the resin sheet A may be coated with a coating for enhancing releasability of the surface. The coating is, for example, a coating of a compound, such as a fluorine compound, having an effect of lowering the friction coefficient of the surface. The resin sheet A having such a coating is disposed on a suction face of a suction unit in such a manner that the one surface (coating surface)is in contact with a work object when the suction unit sucks the work object. In the suction method according to the present invention, the resin sheet A may be disposed on the suction face in such a manner that the coating surface is in contact with a work object when the suction unit sucks the work object. In the method for manufacturing the ceramic capacitor according to the present invention, the resin sheet A may be disposed on the suction face in such a manner that the coating surface is in contact with the ceramic green sheet when the suction unit sucks the ceramic green sheet. Thereby, the releasability of the work object (the ceramic green sheet, for example) from the suction unit is enhanced.

An adhesive may be placed on one surface of the resin sheet A in such a manner that openings of the through holes in the surface remain exposed. The type of the adhesive is not particularly limited. At least a part of the openings of the through holes has only to remain exposed as long as the above-mentioned requirements regarding the air permeance of the resin sheet A are satisfied. The resin sheet A having such an adhesive is disposed on the suction face in such a manner that the one surface (adhesive surface) is bonded to the suction face. In the suction method and the method for manufacturing the ceramic capacitor according to the present invention, the resin sheet A may be disposed on the suction face in such a manner that the adhesive surface is bonded to the suction face.

The method for disposing the resin sheet A, which is the suction sheet, on the suction face of the suction unit is not particularly limited, and a known method may be followed.

The suction method according to the present invention includes a step of allowing the work object to be sucked onto the suction face of the suction unit. Here, the details of the step are not particularly limited as long as the resin sheet A, which is the suction sheet, is disposed on the suction face of the suction unit.

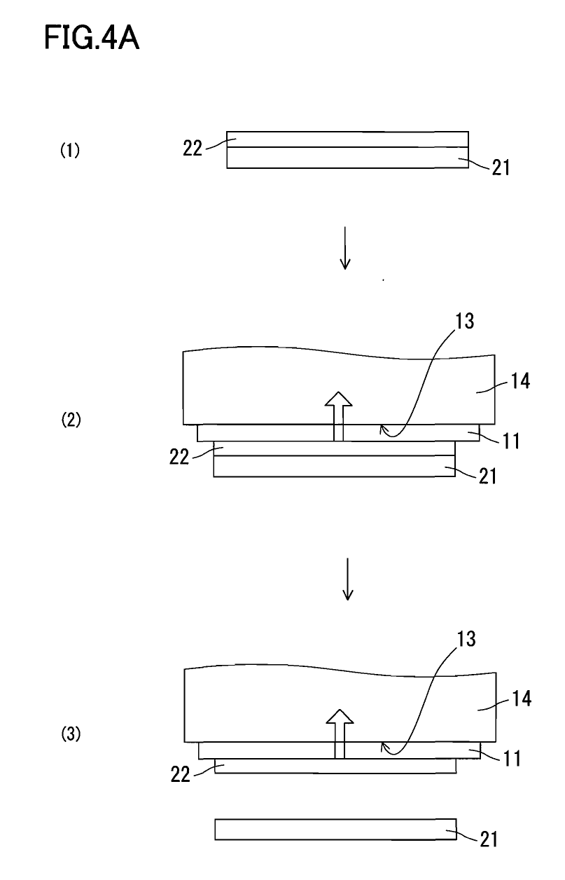

FIG. 3 illustrates an example of the suction method according to the present invention. In the method shown in FIG. 3, a work object 15 is sucked onto a suction unit 14. The resin sheet 11 shown in FIG. 1 is disposed on a suction face 13 of the suction unit 14. The work object 15 is sucked onto the suction face 13 via the resin sheet 11. The suction unit 14 is connected to a pump (not shown) that enables the suction unit 14 to generate a suction force. A plurality of holes 16 are formed in the suction face 13 of the suction unit 14 shown in FIG. 3. The suction force is generated on the suction face 13 of the suction unit 14 through the holes 16. Preferably, a region L1 within which the holes 16 are formed in the suction unit 14 is smaller than a region L2 of the work object 15.

The method for manufacturing the ceramic capacitor according to the present invention includes: a separating step of allowing a ceramic green sheet formed on a release film to be sucked onto a suction face of a suction unit so as to separate the ceramic green sheet from the release film; a laminating step of transferring the separated ceramic green sheet while keeping the separated ceramic green sheet sucked on the suction face, and laminating the separated ceramic green sheet on another ceramic green sheet at a destination of transfer; and a firing step of firing a laminate of the ceramic green sheets obtained by repeating a plurality of times the separating step and the laminating step. Here, the details of each step are not particularly limited as long as the resin sheet A, which is the suction sheet, is disposed on the suction face of the suction unit, and known methods may be followed.

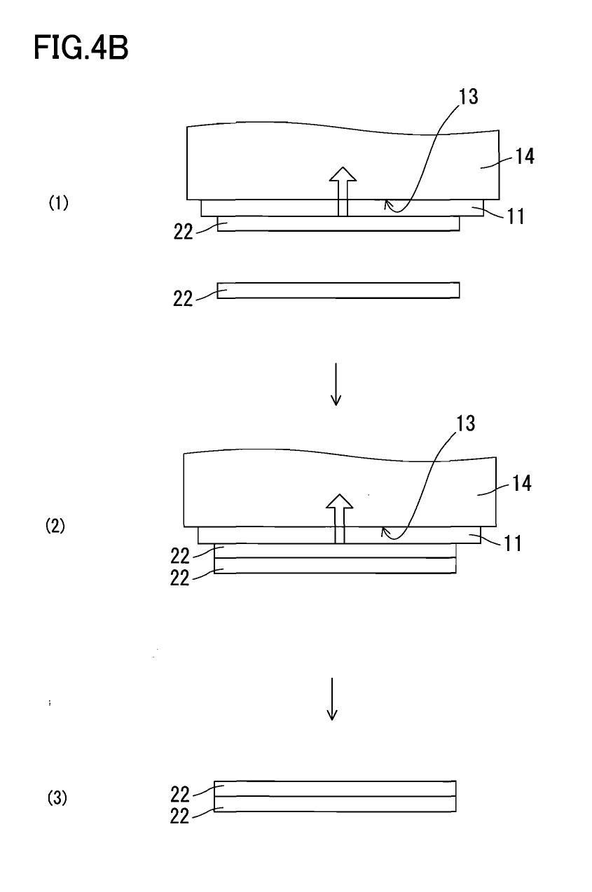

FIG. 4A to FIG. 4C show the steps in an example of the method for manufacturing the ceramic capacitor according to the present invention. FIG. 4A illustrates the separating step, FIG. 4B illustrates the laminating step, and FIG. 4C illustrates the firing step.

In the separating step shown in FIG. 4A, a ceramic green sheet 22 formed on a release film 21 (see (1) in FIG. 4A) is separated from the release film 21 by allowing the ceramic green sheet 22 to be sucked onto the suction face 13 of the suction unit 14 (see (2) and (3) in FIG. 4A). The resin sheet 11 is disposed on the surface of the suction face 13. The ceramic green sheet 22 is sucked onto the suction face 13 via the resin sheet 11.

In the laminating step shown in FIG. 4B, the ceramic green sheet 22 separated in the separating step is transferred while the separated ceramic green sheet 22 is kept sucked on the suction face 13, and the separated ceramic green sheet 22 is laminated on another ceramic green sheet 22 at a destination of transfer (see (1) to (3) in FIG. 4B).

In the firing step shown in FIG. 4C, a laminate 23 of the ceramic green sheets 22 obtained by repeating a plurality of times the separating step shown in FIG. 4A and the laminating step shown in FIG. 4B is fired to obtain a fired product 24. Thereafter, a step of disposing an electrode on the fired product 24, etc. is performed. Thus, the ceramic capacitor is obtained. The laminate 23 shown in FIG. 4C has only eight layers for easy understanding of the illustration. Actually, however, a larger number of the ceramic green sheets 22 may be laminated by repeating the separating step and the laminating step.

The details of the separating step, the laminating step and the firing step in the method for manufacturing the ceramic capacitor according to the present invention may follow a known method for manufacturing a ceramic capacitor.

The method for manufacturing the ceramic capacitor according to the present invention may include, as needed, an arbitrary step other than the separating step, the laminating step and the firing step.

### EXAMPLES

Hereinafter, the present invention is described further in detail using examples. The present invention is not limited to the following examples.

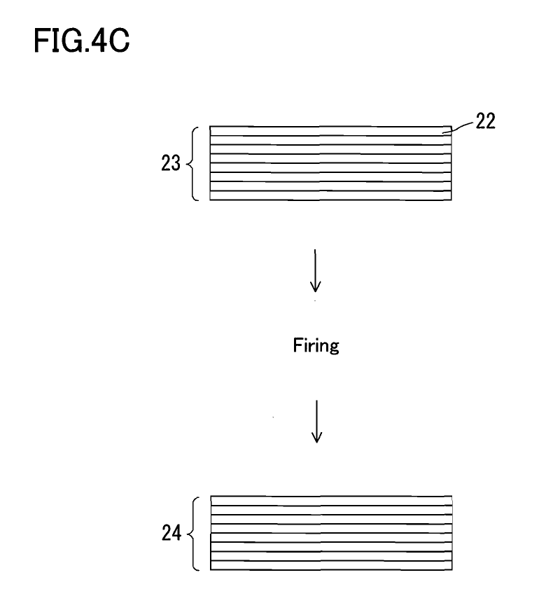

In Examples, the resin sheet A (in Examples 1 and 2) and the UHMWPE porous sheet (in Comparative Example) each was disposed, as the suction sheet, on a suction face 2 of a suction unit 1 shown in FIG. 5. A pressure difference a caused between the air outside the suction unit 1 and the air inside the suction unit 1 was evaluated using a pressure gage 3 when a suction force was generated at the suction unit 1. A smaller pressure difference indicates a higher air permeability of the suction sheet. In the case where a suction sheet 4 was smaller than the suction face 2 of the suction unit 1, the portion of the suction face 2 in which the suction sheet 4 was not disposed was sealed with a tape 5 or the like, as shown in FIG. 5, so that the outside air was aspirated into the suction unit 1 only through the suction sheet 4.

For comparison, a pressure difference b caused between the outside air and the inside air of the suction unit 1 when nothing was disposed on the suction face 2, and a pressure difference c caused between the outside air and the inside air of the suction unit 1 when the suction face 2 was sealed with a resin sheet having no pores were also evaluated. In the case where the air permeability of the suction sheet was high, the value of the pressure difference a when the suction sheet was disposed on the suction face 2 was close to the value of the pressure difference b when nothing was disposed on the suction face 2, and the difference between the value of the pressure difference a when the suction sheet was disposed on the suction face 2 and the value of the pressure difference c when the suction face 2 was sealed was large. The measurement of each pressure difference was made while changing the suction force of the suction unit 1 by setting, using an adjustable valve 6 and a flowmeter 7, the suction force of the suction unit 1 so that the flow rate of the air aspirated into the suction unit 1 when nothing was disposed on the suction face 2 was adjusted to 10 SLM, 20 SLM and 30 SLM. The reference temperature for SLM was 25° C. Reference numeral 8 in FIG. 5 denotes a vacuum pump.

### Example 1

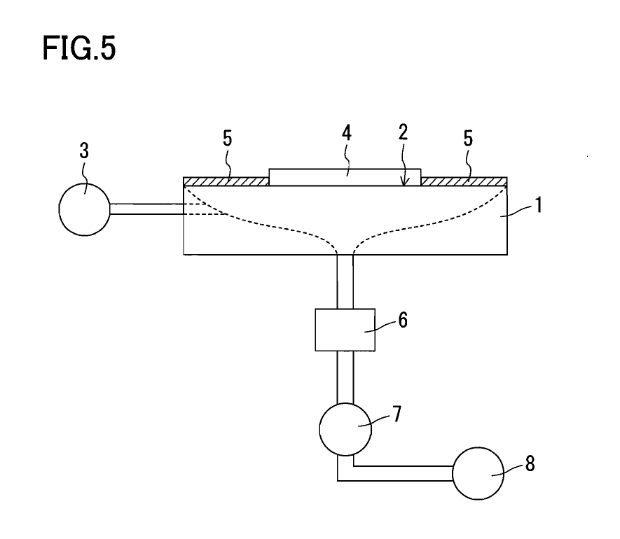

As the resin sheet A, a resin sheet (OxyDisk produced by OXYPHEN) obtained by forming, by ion beam irradiation and etching, many through holes (with an opening diameter of 0.8 μm) in a base sheet (with a thickness of 22 μm) made of PET and having no pores was used. The through holes each were a straight hole having an axis in a thickness direction of the base sheet and an almost uniform inner diameter. FIG. 6 shows an SEM image of the surface of the resin sheet. The Gurley number (Gurley number in the thickness direction) of the resin sheet measured in accordance with JIS P8117 was 2.7 seconds/100 mL. The porosity of the resin sheet was 29.8% (area %). The porosity of the resin sheet was defined as the ratio of the area of openings of the through holes to the area of the surface of the resin sheet, judging from the above-mentioned shape of the through holes. This ratio was determined by binarizing the SEM image of the surface of the resin sheet by image processing. This porosity measuring method was used also in Example 2 below.

### Example 2

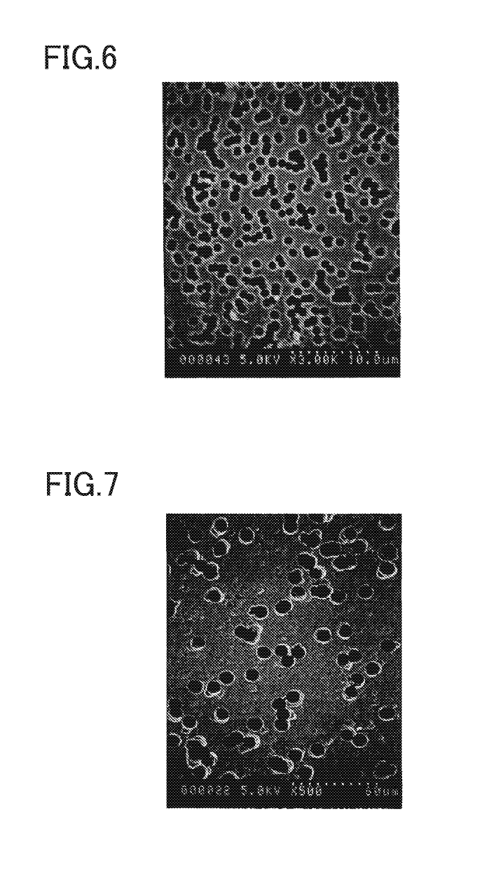

As the resin sheet A, a resin sheet (OxyDisk produced by OXYPHEN) obtained by forming, by ion beam irradiation and etching, many through holes (with an opening diameter of 10 μm) in a base sheet (with a thickness of 22 μm) made of PET and having no pores was used. The through holes each were a straight hole having an axis in a thickness direction of the base sheet and an almost uniform inner diameter. FIG. 7 shows an SEM image of the surface of the resin sheet. The Gurley number (Gurley number in the thickness direction) of the resin sheet measured in accordance with JIS P8117 was 0.06 seconds/100 mL. The porosity of the resin sheet was 11.4% (area %).

### Comparative Example

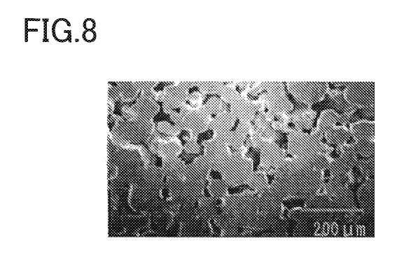

As the suction sheet, an UHMWPE porous sheet (SUNMAP LCT5320S produced by Nitto Denko Corp., with a thickness of 200 μm) was used. FIG. 8 shows an SEM image of the surface of the resin sheet. The average pore diameter of this porous sheet was 20 μm.

Tables 1 to 3 show the evaluation results of Examples 1, Example 2 and Comparative Example, respectively.

TABLE 1
(Example 1)

| | With | | | |
|---|---|---|---|---|
| | nothing | With suction sheet disposed | | |
| Set | disposed | | Actual flow rate | Sealed |
| flow | Pressure | Pressure | of air aspirated | Pressure |
| rate | difference b | difference a | into suction | difference c |
| (SLM) | (kPa) | (kPa) | unit (SLM) | (kPa) |
| 10 | 0.9 | 1.0 | 9.9 | 79.2 |
| 20 | 1.5 | 1.7 | 19.9 | 80.1 |
| 30 | 2.2 | 2.6 | 29.7 | 82.3 |

TABLE 2
(Example 2)

| | With | | | |
|---|---|---|---|---|
| | nothing | With suction sheet disposed | | |
| Set | disposed | | Actual flow rate | Sealed |
| flow | Pressure | Pressure | of air aspirated | Pressure |
| rate | difference b | difference a | into suction unit | difference c |
| (SLM) | (kPa) | (kPa) | (SLM) | (kPa) |
| 10 | 0.4 | 0.5 | 10.1 | 81.6 |
| 20 | 0.9 | 1.2 | 19.9 | 82.6 |
| 30 | 1.6 | 2.2 | 30.0 | 83.0 |

TABLE 3
(Comparative Example)

| | With | | | |
|---|---|---|---|---|
| | nothing | With suction sheet disposed | | |
| Set | disposed | | Actual flow rate | Sealed |
| flow | Pressure | Pressure | of air aspirated | Pressure |
| rate | difference b | difference a | into suction unit | difference c |
| (SLM) | (kPa) | (kPa) | (SLM) | (kPa) |
| 10 | 0.8 | 35.1 | 6.7 | 80.6 |
| 20 | 1.6 | 38.8 | 10.5 | 77.2 |
| 30 | 2.1 | 44.3 | 13.6 | 80.5 |

As shown in Tables 1 to 3, in each of the Examples 1 and 2 in which the resin sheet A was used as the suction sheet, despite of the fact that the diameter of the holes serving as air passages was small, very high air permeability was achieved compared to the air permeability in Comparative Example in which the UHMWPE porous sheet was used as the suction sheet.

### INDUSTRIAL APPLICABILITY

The suction method according to the present invention can be applied to a wide range of applications such as manufacture of a ceramic capacitor, manufacture of a semiconductor wafer, and suction-fixing of a minute part.

The resin sheet used as the suction sheet in each method according to the present invention can be used for a wide range of suction units such as a fixing unit used when cutting or sucking a semiconductor wafer and a suction-fixing unit for a minute part, other than for the purpose of preventing the contact between the ceramic green sheet and the suction face by being disposed on the suction face of the suction unit.

1. A method for allowing a work object to be sucked onto a suction unit, comprising a step of allowing the work object to be sucked onto a suction face of the suction unit,
wherein a resin sheet that prevents direct contact between the work object and the suction face and has air permeability in a thickness direction of the resin sheet is disposed on the suction face,
the resin sheet is a non-porous sheet in which two or more through holes extending in a thickness direction of the non-porous sheet are formed,
the through holes are straight holes extending linearly through the resin sheet,
the through holes have a diameter of 20 μm or less, and
the resin sheet has an air permeance, in the thickness direction, of 10 seconds/100 mL or less in terms of Gurley number measured in accordance with JIS P8117.

2. The method for allowing the work object to be sucked onto the suction unit according to claim 1, wherein the work object is a ceramic green sheet.

3. The method for allowing the work object to be sucked onto the suction unit according to claim 1, wherein the resin sheet is composed of at least one resin selected from polyethylene terephthalate (PET), polycarbonate (PC), polyimide (PI), polyethylene naphthalate (PEN) and polyvinylidene fluoride (PVdF).

4. The method for allowing the work object to be sucked onto the suction unit according to claim 1,
wherein one surface of the resin sheet is coated with a coating for enhancing releasability of the surface, and
the resin sheet is disposed on the suction face in such a manner that the one surface is in contact with the work object when the suction unit sucks the work object.

5. The method for allowing the work object to be sucked onto the suction unit according to claim 1,
wherein an adhesive is placed on one surface of the resin sheet in such a manner that openings of the through holes in the surface remain exposed, and
the resin sheet is disposed on the suction face in such a manner that the one surface is bonded to the suction face.

6. A method for manufacturing a ceramic capacitor, comprising:
a separating step of allowing a ceramic green sheet formed on a release film to be sucked onto a suction face of a suction unit so as to separate the ceramic green sheet from the release film;
a laminating step of transferring the separated ceramic green sheet while keeping the separated ceramic green sheet sucked on the suction face, and laminating the separated ceramic green sheet on another ceramic green sheet at a destination of transfer; and
a firing step of firing a laminate of the ceramic green sheets obtained by repeating a plurality of times the separating step and the laminating step,
wherein a resin sheet that prevents direct contact between the ceramic green sheet and the suction face and has air permeability in a thickness direction of the resin sheet is disposed on the suction face,
the resin sheet is a non-porous sheet in which two or more through holes extending in a thickness direction of the non-porous sheet are formed,
the through holes are straight holes extending linearly through the resin sheet,
the through holes have a diameter of 20 μm or less, and
the resin sheet has an air permeance, in the thickness direction, of 10 seconds/100 mL or less in terms of Gurley number measured in accordance with JIS P8117.

7. The method for manufacturing the ceramic capacitor according to claim 6, wherein the resin sheet is composed of at least one resin selected from polyethylene terephthalate (PET), polycarbonate (PC), polyimide (PI), polyethylene naphthalate (PEN) and polyvinylidene fluoride (PVdF).

8. The method for manufacturing the ceramic capacitor according to claim 6,
wherein one surface of the resin sheet is coated with a coating for enhancing releasability of the surface, and
the resin sheet is disposed on the suction face in such a manner that the one surface is in contact with the ceramic green sheet when the suction unit sucks the ceramic green sheet.

9. The method for manufacturing the ceramic capacitor according to claim 6,
wherein an adhesive is placed on one surface of the resin sheet in such a manner that openings of the through holes in the surface remain exposed, and
the resin sheet is disposed on the suction face in such a manner that the one surface is bonded to the suction face.
